(19) United States
(12) Patent Application Publication
(10) Pub. No.: US 2026/0251180 A1
(43) Pub. Date: Aug. 27, 2026

(54) BEARING, MACHINE, LUBRICATION METHOD & USE

(71) Applicant: AKTIEBOLAGET SKF, GOTEBORG (SE)

(72) Inventors: Yi SHEN, Shanghai (CN); Feng LIN, Shanghai (CN); Guo Jiang ZHANG, Shanghai (CN); Yu Xin ZHOU, Shanghai (CN); Bo HAN, Shanghai (CN); Linxin LU, Shanghai (CN)

(21) Appl. No.: 18/995,320

(22) PCT Filed: Jul. 10, 2023
(86) PCT No.: PCT/EP2023/069058

§ 371 Date: Jan. 16, 2025

(30) Foreign Application Priority Data
Aug. 2, 2022 (CN) 202210921212.8

(51) Int. Cl. F16C 33/66; F16C 19/38; F16C 33/76

(52) U.S. Cl. CPC F16C 33/6633; F16C 19/38; F16C 33/76; F16C 2208/10; F16C 2300/54; F16C 2322/12

(57) ABSTRACT

A bearing (20) is provided for a machine (26), such as a hot leveler, in which at least part of the bearing will be subjected to a temperature of at least 150° C. during use of the machine. The bearing has a sealed space containing rolling elements (13) and a high temperature-resistant lubricating grease (22) that is an admixture of a thickener and a synthetic base oil. The high temperature-resistant lubricating grease has a dropping point of at least 250° C. and an NLGI consistency grade of 1.0 to 1.5. At least one high temperature resistant seal (24) serves to seal the sealed space.

### CROSS-REFERENCE

This application is the US national stage of International Patent Application No. PCT/EP2023/069058 filed on Jul. 10, 2023, which claims priority to Chinese Patent Application No. 202210921212.8 filed on Aug. 2, 2022.

### TECHNICAL FIELD

The present teachings concern a bearing that is suitable for use in a machine, such as a hot leveler, in which at least part of the bearing will be subjected to a temperature of at least 150° C. during the use of the machine. The present teachings also concern such a machine comprising at least one such bearing. The present teachings further concern a method for lubricating such a bearing and the use of at least one such bearing in such a machine.

### BACKGROUND OF THE INVENTION

In many industrial applications, such as iron and steel production processes, bearings are subjected to high temperature conditions in which the operating temperature of a bearing can exceed 200° C.

For example, a metal product, such as metal strip (plate), may pass through (along, over) roll lines and other machines, such as hot levelers which flatten, roll or extrude the metal product into its final shape

The temperature of the bearings used in such high temperature applications is usually controlled by a cooling system, such as water circulation, to extend the useful service life of the bearings. In addition or the alternative, various lubrication systems, such as circulating oil lubrication, oil-air lubrication or oil mist lubrication, may be utilized to provide cooling effect. However, in some applications, such as supporting rollers in a hot leveler, a dedicated cooling system cannot be employed due to space or design restrictions. It is therefore a challenge to provide a lubrication system for such an application.

The bearings used in supporting rollers in a hot leveler are, for example, lubricated using an oil-air lubrication system. The oil-air lubrication system will however age after a period of use, resulting in many problems, such as oil leakage from the bearings. If lubricant from a bearing leaks and drips onto the surface of a product passing though the hot leveler, the surface of the rolled product may be affected, its quality may be decreased, and it may need to be scrapped.

The use of an oil-air lubrication cooling system in a hot leveler therefore presents a significant risk. However, due to the requirements of the production process and the system complexity, it is very difficult to install an additional bearing cooling system. There is namely very little space for an additional lubrication system, which normally comprises a controller or timer, a pump and lubricant reservoir, metering valves, distributors and fittings, and supply and feed lines.

Apart from high temperatures, the bearings used in high temperature production processes are also subjected to extreme wear due to the high (heavy) loads, large temperature variations, high corrosion, abrasion, and high contamination during use. These harsh operating conditions can make adequate lubrication of bearings difficult and limit productivity. In particular, the service life of bearings in such applications is relatively short compared with other components used in a high temperature application. For this reason, the bearings must be exchanged or overhauled frequently. If the bearings fail, they have to be substituted within the shortest possible time so that the downtime of the manufacturing plant, such as a heavy plate milling plant, is minimized. Exchanging bearings, such as backup roller bearings, may be difficult and time consuming as it may be necessary to dismount part of the machine in which they are mounted.

### SUMMARY OF THE INVENTION

It is therefore one non-limiting object of the present teachings to disclose techniques for improving a bearing or a bearing combination solution that is suitable for a machine in which at least part of the bearing, or the entire bearing, is subjected to a temperature of at least 150° C., at least 200° C., at least 250° C., or at least 300° C. during the use of the machine, i.e. at any time before, during or after the use of the machine, to produce or process a product. Such a machine may for example be a hot-leveler or any other machine used in the metal or metal-alloy-making industry, such as in the iron-or steelmaking industry.

In one aspect of the present teachings, a bearing may include a high temperature-resistant lubricating grease and a high temperature-resistant seal; i.e., a sealed grease-lubricated bearing is provided. The high temperature-resistant lubricating grease comprises, or consists of, a thickener and a synthetic base oil. The high temperature-resistant lubricating grease preferably has a dropping point of at least 250° C. and a National Lubricating Grease Institute (NLGI) consistency grade of 1.0 to 1.5.

The dropping point of a lubricating grease is an indication of the heat resistance of the grease and is the temperature at which it passes from a semi-solid to a liquid state under specific test conditions. It is dependent on the type of thickener used and the cohesiveness of the synthetic base oil and the thickener of the high temperature-resistant lubricating grease. The dropping point indicates the upper temperature limit at which a grease retains its structure, although it is not necessarily the maximum temperature at which a grease can be used. The dropping point of a grease may be determined using the test procedures that are given in ASTM International standards D-566 and D-2265. The use of a high temperature-resistant lubricating grease that has a dropping point of at least 250° C. enables the bearing to be used in high temperature applications in which at least part of the bearing is subjected to a temperature of at least 150° C. during its use.

The NLGI consistency grade of a lubricating grease expresses a measure of the relative hardness of the high temperature-resistant lubricating grease, as specified by the standard classification of lubricating greases established by the National Lubricating Grease Institute. NLGI's classification defines nine grades, each associated with a range of ASTM worked penetration values, measured using the test defined by standard ASTM D217 entitled “Cone penetration of lubricating grease”. The high temperature-resistant lubricating grease used in bearings according to the teachings is preferably softer than conventional lubricating grease, which has an NLGI of 2.0 or more. Such a high temperature-resistant lubricating grease has a relatively low churning friction in the temperature range from ambient temperature to the required high operating temperature.

Grease churning may occur during the running-in phase of a bearing, especially in cold environments, when a bearing must churn through (stiff) lubricant as it performs its regular task. That is, bearings require a certain amount of force (or torque) to begin turning and to continue turning once they are set in motion. Running torque is usually less than starting torque. If the consistency of a grease is too high, it leads to drag resistance. In this case, the machine in which the bearing is used must work harder to re-distribute the grease, which results in higher operating temperatures, decreased efficiency and a reduction in the service life of both the lubricant and the machine. The excessive friction torque can also block the rotation of rollers and result in sticking-steel damage or surface smearing. If the consistency is too low, then excessive grease leakage can occur, causing machine wear and premature failure.

By selecting a high temperature-resistant lubricating grease having an NLGI consistency grade consistency grade of 1.0 to 1.5, which is softer than conventional grease, churning losses will be relatively low and rotation of the bearing will not be hindered during the running-in phase as much as when using conventional grease. Additionally, the running-in time can be substantially shortened. Such a running-in phase can last, for example, for up to one month in systems using conventional grease. Optimized bearing friction can reduce the risk of sticking-steel damage.

The inventors have found that a sealed grease-lubricated bearing according to the present teachings provides a reliable lubrication solution even if used without a bearing cooling system in a machine, such as a hot leveler. The bearing can have a relatively long service life, i.e., of six months or more, and will not require maintenance or re-lubrication during its use, which increases the reliability (durability) of the machine in which the bearing is used and reduces lubricant consumption.

Additionally, since bearings according to the present teachings are lubricated with a high temperature-resistant lubricating grease and comprise at least one high temperature-resistant seal, it provides extra protection against lubricant leakage and dripping, as well as protection against lubricant contamination, which results in less lubricant being spilled. This reduces the risks of early bearing failure, product quality degradation and product scrapping (waste). Unplanned downtime caused by lubricant leakage or lubrication system failure is thereby reduced. Furthermore, additional problems caused by having to provide a lubrication system to cool the bearing, such as increased system complexity, increased energy consumption, increased need of replacement spare parts, as well as increased installation, maintenance and repair costs, are thereby avoided. Production efficiency, cost savings and decreased environmental impact can consequently be realized by utilizing a bearing according to the present teachings.

According to an embodiment of the present teachings, the bearing is suitable for use with (in) a machine such as a hot leveler or straightener, a continuous casting machine, a hot rolling mill, a roller table, a plate mill, a machine used in a metal-or metal-alloy making process, such as an iron or steel production process, or any machine producing or processing a large and/or heavy product, such as a product having a width greater than 2 m, greater than 3 m, greater than 4 m or greater than 5 m, and/or a thickness greater than 5 mm, greater than 10 mm, greater than 20 mm, greater than 30 mm, greater than 40 mm, greater than 50 mm or greater than 60 mm.

The high temperature-resistant lubricating grease used in bearings according to the present teachings comprises one or more synthetic base oils, rather than one or more mineral (hydrocarbon) base oils. The high temperature-resistant lubricating grease may be a lubricant, such as a silicone high temperature-resistant lubricating grease, in which both the thickener and the synthetic base oil are synthetic. The high temperature-resistant lubricating grease can be used with a high temperature-resistant seal comprising natural rubber or other rubbers because it will not soften these materials.

According to an embodiment of the present teachings, the thickener comprises at least one of the following: a polyurea, a polytetrafluoroethylene, a calcium sulfonate complex, a lithium complex, modified bentonite, or any other thickener that will result in a grease having a dropping point of at least 250° C., which can be used to make high temperature-resistant lubricating grease that has a dropping point of at least 250° C. and an NLGI consistency grade of 1.0 to 1.5.

According to an embodiment of the present teachings, the synthetic base oil comprises at least one of the following: a polyether oil, an ester oil, a silicone oil, a perfluoropolyether (PFPE) oil, or any other synthetic oil. Such synthetic base oils exhibit excellent chemical stability and a low volatilization rate at high temperatures; i.e., they may be used in applications in which they are subjected to a temperature of at least 150° C. during their use.

According to an embodiment of the present teachings, the high temperature-resistant lubricating grease may also comprise at least one of the following additives: a tackifier, an elastomer, an anti-wear additive, an anti-corrosion additive, an extreme pressure (EP) additive, and/or an anti-oxidant.

According to an embodiment of the present teachings, the high temperature-resistant seal comprises at least one of the following: a hydrogenated acrylonitrile butadiene rubber (HNBR), a fluorocarbon rubber (FKM) or any other high temperature-resistant elastomer material, i.e. any other sealing material that exhibits good temperature resistance above 150° C. so that the high temperature-resistant seal may be used at a temperature of at least 150° C., at least 200° C., or at least 250° C. Sealing prolongs the service life of the bearing in contaminated environments and means that the sealed grease-lubricated bearing will not require re-lubrication during its use, which can reduce lubricant consumption dramatically.

According to an embodiment of the present teachings, the bearing (i.e. a sealed space within the bearing) is filled with the high temperature-resistant lubricating grease up to a fill level of 50-95%. Such a fill level will decrease the risk of grease leaking out of the bearing. Such a fill level will also further reduce the risk of lubricant churning during the running-in phase of the bearing. If the lubricant level is namely too high, then the machine in which the bearing is used must work harder to push through the lubricant, which results in higher operating temperatures, decreased efficiency, and a reduction in the service life of both the lubricant and the machine.

The present teachings also concern a machine, such as a hot leveler, in which at least part of the at least one bearing will be subjected to a temperature of at least 150° C., at least 200° C., at least 250° C., at least 300° C. during the use of the machine. The machine comprises at least one sealed grease-lubricated bearing according to any of the embodiments of the present teachings. The at least one grease-lubricated bearing is preferably located only at one or more locations where at least part of the or each bearing is subjected to a high temperature during the use of the machine. Since the high temperature-resistant lubricating grease used in bearings according to the present teachings is quite expensive compared to conventional grease, cost savings can be realized by providing the sealed grease-lubricated bearing only in locations where such a bearing is needed, i.e., only in locations in which at least part of the bearing is subjected to an operating temperature exceeding 150° C. during its use.

The present teachings further concern a method for lubricating a bearing of a machine, such as a hot leveler, in which at least part of the at least one bearing will be subjected to a temperature of at least 150° C., at least 200° C., at least 250° C., or at least 300° C. during the use of the machine. The method comprises providing at least one sealed grease-lubricated bearing according to the present teachings in at least one location where the at least one bearing will be subjected to an operating temperature exceeding 150° C. during its use.

According to an embodiment of the present teachings, the method comprises filling the bearing (i.e. a sealed space within the bearing) with the high temperature-resistant lubricating grease to a fill level of 50-95%. The fill level selected will depend on the maximum temperature to which the at least one sealed grease-lubricated bearing is subjected during the use of the machine, which will in turn depend on the maximum temperature of the products being produced or processed by the machine in which the at least one sealed grease-lubricated bearing is provided. The higher the maximum temperature of a product, the higher the lubricant fill level should be. Since the temperature of a product is highest at the centre of the product, products having a greater width and/or a greater thickness will require a higher lubricant fill level.

The present teachings also concern the use of at least one grease-lubricated bearing according to any of the embodiments in a machine in which at least part of the at least one grease-lubricated bearing is subjected to a temperature of at least 150° C., at least 200° C., at least 250° C., or at least 300° C. during the use of the machine. The machine may be a hot leveler or straightener, a continuous casting machine, a hot rolling mill, a roller table, a heavy plate mill, a machine used in a metal-or metal-alloy making process, such as an iron or steel production process, or a machine producing or processing a large and/or heavy product, i.e. a product having a width greater than 1 m. greater than 2 m, greater than 3 m, greater than 4 m, greater than 5 m, and/or a thickness greater than 5 mm, greater than 10 mm, greater than 20 mm, greater than 30 mm, greater than 40 mm, greater than 50 mm, greater than 60 mm.

### BRIEF DESCRIPTION OF THE DRAWINGS

The present teachings will hereinafter be further explained with reference to non-limiting examples and the appended figures, in which:

FIG. 1 shows a conventional bearing design,

FIG. 2 shows a bearing according to an embodiment of the present teachings, and

FIG. 3 shows the steps of a method according to an embodiment of the present teachings.

It should be noted that the drawings have not necessarily been drawn to scale and that the dimensions of certain features may have been exaggerated for the sake of clarity.

It should also be noted that any feature described with reference to a particular embodiment of a bearing, machine, method or use according to the present teachings, may be combined with the features of any other embodiment of the bearing, machine, method or use according to the present teachings unless the description explicitly excludes such a combination.

### DETAILED DESCRIPTION OF EMBODIMENTS OF THE PRESENT INVENTION

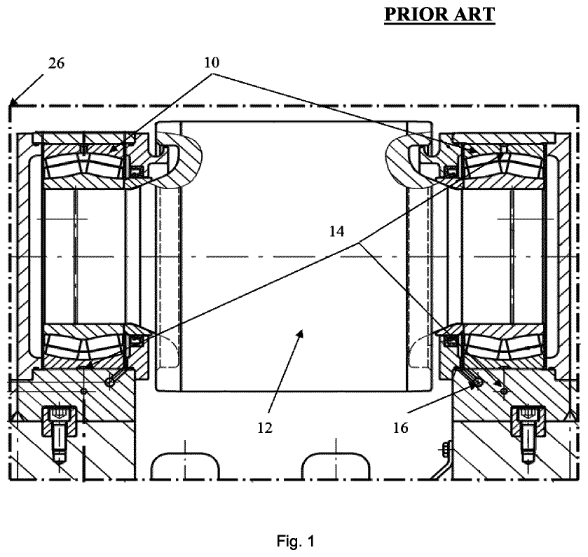

FIG. 1 shows a conventional (prior art) bearing design, namely two open spherical roller bearings 10 supporting a backup roller 12 of a hot leveller 26 in a heavy plate mill plant. In such an application, the temperature of at least part of each bearing 10 can vary between ambient temperature and 220° C. or more during the use of the hot leveler support roller 26. The conventional bearing design 10 is an open bearing design that does not have a seal and that is not filled with grease, but rather uses oil-air lubrication. A mixture of oil and air enters the bearing 10 through bearing outer ring lubrication holes 14 and leaves the bearing through housing outlet holes 16.

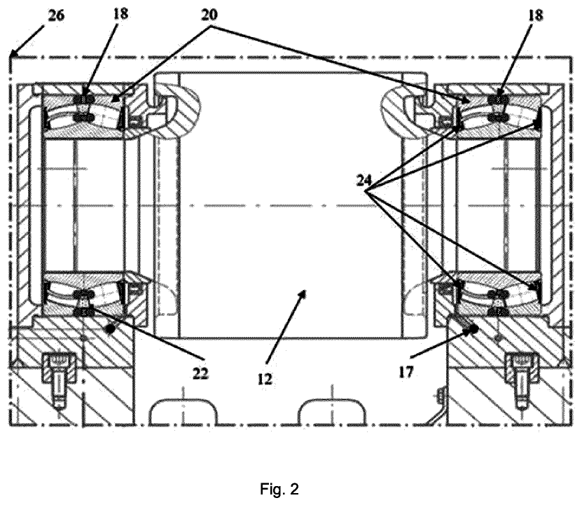

FIG. 2 schematically shows an example of a bearing system that includes two spherical roller bearings 20, each comprising a bearing outer ring 11, a bearing inner ring 12, rolling elements 13 disposed between the bearing outer ring 11 and the bearing inner ring 12, a high temperature-resistant lubricating grease 22 and at least one high temperature-resistant seal 24, according to an embodiment of the present teachings. Such a bearing 20 can be used to replace the above-described conventional open bearing 10 and comprises plugs 17 and 18 to prevent the leakage of high temperature-resistant lubricating grease 22 from the housing outlet holes and the bearing outer ring lubrication holes, respectively. The use of such a bearing 20 change the lubrication model from oil-air lubrication to grease lubrication, which enables totally maintenance free operation.

Each bearing 20 contains a high temperature-resistant lubricating grease 22 that has a dropping point of at least 250° C. and an NLGI consistency grade of 1.0 to 1.5 within a sealed space delimited by the bearing outer and inner rings 11, 12, the seal(s) 24 and the plugs 17, 18. The rolling elements 13 are disposed within the sealed space. The high temperature-resistant lubricating grease 22 may for example comprise 10-40% of a thickener and 60-90% of a synthetic base oil.

The high temperature-resistant lubricating grease 22 contained in the sealed space may preferably comprise a synthetic fluorinated oil and a PTFE thickener. Such a high temperature-resistant lubricating grease is suitable for use at operating temperatures up to 240° C. and in aggressive environments such as in an acidic or alkaline environment, in a vacuum or in an oxygen atmosphere.

Each bearing 20 comprises high temperature-resistant seals 24. Each high temperature-resistant seal 24 may consist of, or comprise, hydrogenated acrylonitrile butadiene rubber (HNBR), a fluorocarbon rubber (FKM) or any other high temperature-resistant elastomer material. These sealing materials exhibit good wear resistance and good high temperature resistance as well as resistance to chemical attack and ageing.

After the initial filling of each bearing 20 with a high temperature-resistant lubricating grease 22, the high temperature-resistant lubricating grease 22 will be located between and around the rolling elements 13.

During the running-in phase, the high temperature-resistant lubricating grease 22 will be pushed into the un-swept volume of each bearing 20 (onto the high temperature-resistant seals 24 or onto the bearing ring shoulders) or will end up attached to the cage(s) of the bearing(s) 20. From these locations, the high temperature-resistant lubricating grease 22 will slowly provide the raceways with lubricant by either bleeding or shear. In this bleeding phase, the lubricating film will be governed by a feed and loss mechanism in which the raceways are fed with high temperature-resistant lubricating grease 22 from high temperature-resistant lubricating grease reservoirs. Another feed mechanism is occasional replenishment caused by a softening of the high temperature-resistant lubricating grease 22 close to the contacts due to local heat development in the bearing 10.

The high temperature-resistant lubricating grease 22 thereby protects the machine elements because it lubricates against corrosion and wear, it helps to dissipate heat, seal out solid and liquid contamination, and reduces noise. Adequate lubrication enables smooth continuous operation of the machine in which the bearing is provided, with only mild wear, and without excessive stresses or seizures.

If such a bearing 20 is used in a hot leveler 26 to level a plurality of heavy plates, such as steel plates having a width of at least 2 metres and a thickness of at least 5 mm, a lubricant fill level of 50% may be used. A fill level of 55% up to 95% may be used for steel plates having a width greater than 2 metres and/or a thickness greater than 5 mm.

According to an embodiment of the present teachings, the bearing system preferably lacks a cooling system; i.e., the bearing(s) 20 is (are) used without a cooling system to cool the bearing(s) 20 during its use. Bearings according to the present teachings thereby eliminate the need for an oil-air lubrication system or any other cooling system.

It should be noted that bearings 20 according to the present present teachings may be any type of bearing, such as a rolling-element bearing, a ball bearing, a cylindrical roller bearing, a spherical roller bearing, a tapered roller bearing, a needle bearing, a toroidal roller bearing, a ball thrust bearing, a roller thrust bearing, a tapered roller thrust bearing, a Compact Aligning Roller Bearing (CARB®), an angular contact ball bearing (ACBB), a deep groove ball bearing (DGBB), an angular contact ball bearing, a spherical roller bearing used in a continuous caster line, a backing bearing, a slewing bearing or a ball screw, or a bearing for any high temperature application in which it is subjected to a temperature of at least 150° C.

According to an embodiment of the present teachings, the finished or semi-finished component is one of the following: a bearing component, such as an inner or outer bearing ring, a bearing raceway, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a Compact Aligning Roller Bearing (CARB®), an angular contact ball bearing (ACBB), a deep groove ball bearing (DGBB), an angular contact ball bearing, a spherical roller bearing used in a continuous caster line, a backing bearing, a slewing bearing or a ball screw, a finished or semi-finished transmission component, such as a sprocket, a gear, a bushing, a hub, a coupling, a bolt, a screw, a shaft, such as a spindle shaft, a roller or roller mantle, a seal, a tool, a metal wheel, a wire, or any other finished or semi-finished component for an application in which it is subjected to Hertzian contact stress, or alternating Hertzian contact stress, or any finished or semi-finished structural component.

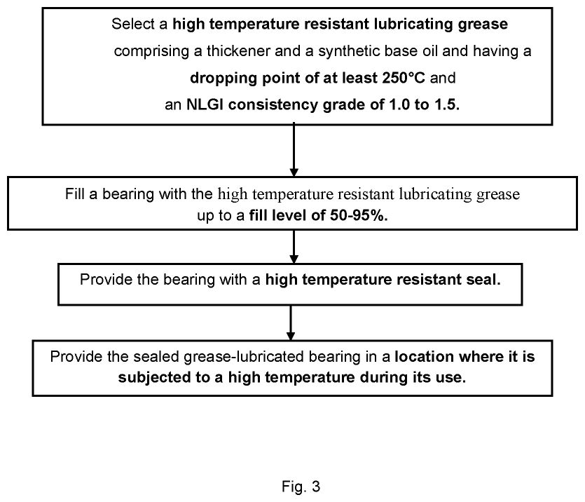

FIG. 3 shows the steps of an exemplary method for lubricating a bearing according to the present teachings for a machine, such as a hot leveler. Such method comprises the steps of selecting a high temperature-resistant lubricating grease comprising, or consisting of, a thickener and a synthetic base oil, and having a dropping point of at least 250° C. and an NLGI consistency grade of 1.0 to 1.5, filling a bearing with the high temperature-resistant lubricating grease up to a fill level of 50-95% depending on the maximum temperature to which the bearing is subjected during the use of the machine and sealing the bearing with at least one high temperature-resistant seal. The sealed grease-lubricated bearing may then be provided in a location where it is subjected to a high temperature during its use.

Using a bearing according to the present teachings may enable a machine to operate for a long or longer period of time without stopping, whereby the machine may for example continuously produce or process several thousands of metres of metal or metal alloy products, such as sheets or plates.

Further modifications of the invention within the scope of the claims will be apparent to a skilled person.

1. A bearing configured for a machine in which at least part of said bearing will be subjected to a temperature of at least 150° C. during use of said machine, said bearing comprising:
a bearing outer ring and a bearing inner ring,
rolling elements disposed between the bearing outer ring and the bearing inner ring,
a high temperature-resistant lubricating grease comprising a thickener and synthetic base oil, said high temperature-resistant lubricating grease having a dropping point of at least 250° C. and an NLGI consistency grade of 1.0 to 1.5, and
at least one high temperature-resistant seal,
wherein:
the high temperature-resistant lubricating grease fills 50-95% of a sealed space defined, at least in part, by the bearing outer ring, the bearing inner ring and the at least one high temperature-resistant seal, and
the rolling elements are disposed within the sealed space.

2. The bearing according to claim 1, wherein said bearing is configured for a hot leveler or straightener, a continuous casting machine, a hot rolling mill, a roller table, a plate mill, a machine for a metal-or metal-alloy making process, such as an iron or steel production process, or a machine producing or processing a product having a width greater than 2 m and/or a thickness greater than 5 mm.

3. The bearing according to claim 1, wherein said thickener of said high temperature-resistant lubricating grease comprises at least one compound or material selected from the group consisting of: a polyurea, a polytetrafluoroethylene, a calcium sulfonate complex, a lithium complex, and modified bentonite.

4. The bearing according to claim 1, wherein said synthetic base oil of said high temperature-resistant lubricating grease comprises at least one oil selected from the group consisting of: a polyalphaolefin, a polyether, an ester oil, a silicone oil, and a perfluoropolyether (PFPE).

5. The bearing according to claim 1, wherein said at least one high temperature-resistant seal comprises a hydrogenated acrylonitrile butadiene rubber (HNBR) or a fluorocarbon rubber (FKM).

6. (canceled)

7. A machine comprising at least one bearing according to claim 1 rotatable supporting a roller.

8.-10. (canceled)

11. The machine according to claim 7, wherein the machine is a hot leveler or straightener, a continuous casting machine, a hot rolling mill, a roller table, a plate mill, a machine for a metal- or metal-alloy making process, or a machine configured to produce or process a product having a width greater than 2 m and/or a thickness greater than 5 mm.

12. The bearing according to claim 3, wherein said synthetic base oil of said high temperature-resistant lubricating grease comprises at least one oil selected from the group consisting of: a polyalphaolefin, a polyether, an ester oil, a silicone oil, and a perfluoropolyether (PFPE).

13. The bearing according to claim 12, wherein the at least one high temperature-resistant seal comprises a hydrogenated acrylonitrile butadiene rubber (HNBR) or a fluorocarbon rubber (FKM).

14. The bearing according to claim 1, wherein the high temperature-resistant lubricating grease comprises a synthetic fluorinated oil and a PTFE thickener.

15. The bearing according to claim 14, wherein the at least one high temperature-resistant seal comprises a hydrogenated acrylonitrile butadiene rubber (HNBR) or a fluorocarbon rubber (FKM).

16. A method comprising
filling 50-95% of the sealed space of the bearing according to claim I with the high temperature-resistant lubricating grease, and
operating a roller that is rotatably supported by the bearing such that at least part of the bearing is subjected to a temperature of at least 150° C.

17. The method according to claim 16, wherein the bearing is not provided with a cooling system.
